(19) United States
(12) Patent Application Publication
(10) Pub. No.: US 2012/0197687 A1
(43) Pub. Date: Aug. 2, 2012

(54) METHOD AND APPLICATION FOR PUBLICLY DISPLAYING CELL PHONE PHOTOGRAPHS

(75) Inventors: Lawrence Mansour, Shelby Township, MI (US); Martin Yousif, Troy, MI (US)

(73) Assignee: Optime Inc., Sterling Heights, MI (US)

(21) Appl. No.: 13/348,156

(22) Filed: Jan. 11, 2012

Related U.S. Application Data
(60) Provisional application No. 61/436,718, filed on Jan. 27, 2011.

(51) Int. Cl. G06Q 30/02; G06Q 10/00; G06F 15/16

(52) U.S. Cl. 705/12; 709/219; 705/14.4

(57) ABSTRACT

The present invention provides for a computer based method of uploading and displaying media taken by a user on a mobile device wherein the media, such as a photograph, is displayed on a public display unit. The method comprises the steps of downloading an application on a mobile device wherein the application is operable to allow a user to take a photograph on the mobile device. The method further includes the steps of uploading the photograph to a computer based database server, storing the photograph in a first file, monitoring the photograph for inappropriate content, storing the photograph in a second file if the photograph is deemed appropriate for public viewing, and displaying the photograph on the public display unit. The present invention requires the user to enter an access code displayed only at the venue.

### CROSS-REFERENCE TO RELATED APPLICATIONS

This application claims priority of U.S. Provisional Patent Application No. 61/436,718 filed Jan. 27, 2011, the contents of which are incorporated herein by reference.

### FIELD OF THE INVENTION

This invention relates generally to applications for smart phones. In particular, this invention relates to an application for taking a photograph or video on a cell phone and uploading said photograph or video through the application allowing it to be publicly displayed.

### BACKGROUND OF THE INVENTION

It is known in the art to take a photograph on a cell phone or camera and transmit the photograph via email wherein the photograph sent via email is uploaded to a public display screen. None of the previously known methods disclose strictly limiting how or where a photograph can be taken. Previous inventions do not allow for the prevention of uploading a photograph to a public display screen where a user uploading a photograph is not currently located at the venue having the public display screen. The previous known methods do not prevent a user from uploading a photograph to a venue when that user is in an entirely different location.

Accordingly, the need for an application intended for use on a mobile device, specifically a mobile application, allowing a user to take a photograph and upload said photograph based on specified data to a venue system or module and allowing said photograph to be publicly displayed is not known and is highly desirable within the art and further allowing communication from the mobile device to a computer through other means aside from SMS/text/MMS or wireless/Bluetooth.

### SUMMARY OF THE INVENTION

The present invention provides for a server based method of uploading and displaying photographs or other media taken by a user on a mobile device wherein the photographs or media are displayed on a public display unit. The method comprises the steps of downloading an application on a mobile device wherein the application is operable to allow a user to take a photograph on the mobile device. The method further includes the steps of uploading the photograph to a computer based database server, storing the photograph in a first file, monitoring the photograph for inappropriate content, storing the photograph in a second file if the photograph is deemed appropriate for public viewing, and displaying the photograph on the public display unit. The present invention requires the user to enter an access code displayed only at the venue. This allows forwarding of a picture to the correct venue, thinking of it as a shipping address. The application downloaded by the user on the mobile device requires the input of the access code before the user is allowed to take a photograph. Accordingly, the present invention provides for a method and mobile device application allowing a user to take a photograph or video through a mobile device application. In an alternative embodiment, the application only allows the user to take a photograph if the user is in a correct location based on GPS satellites. The application is downloadable through a variety of mobile device application configurations for smart phones such as iTunes®, Android®, Windows, Palm or Blackberry®. When a user is at a club, party, bar, event, etc., the user is able to take a picture from their smart phone and transmit the photo to a server which in turn transmits the photo to a monitor at the venue. The monitor and computer unit at the venue sequence the photos and project them or display them accordingly on TV monitors or screens.

### BRIEF DESCRIPTION OF THE DRAWINGS

FIG. 1 shows a perspective environmental view of the system and method;

FIG. 2 illustrates a flowchart of one embodiment of the present invention;

FIG. 3 illustrates a perspective flowchart of the method according to the present invention;

FIG. 4 illustrates a flowchart of the method as described in the present invention; and

FIG. 5 illustrates a flowchart of the method of a detailed embodiment of the present invention.

### DETAILED DESCRIPTION OF THE DRAWINGS

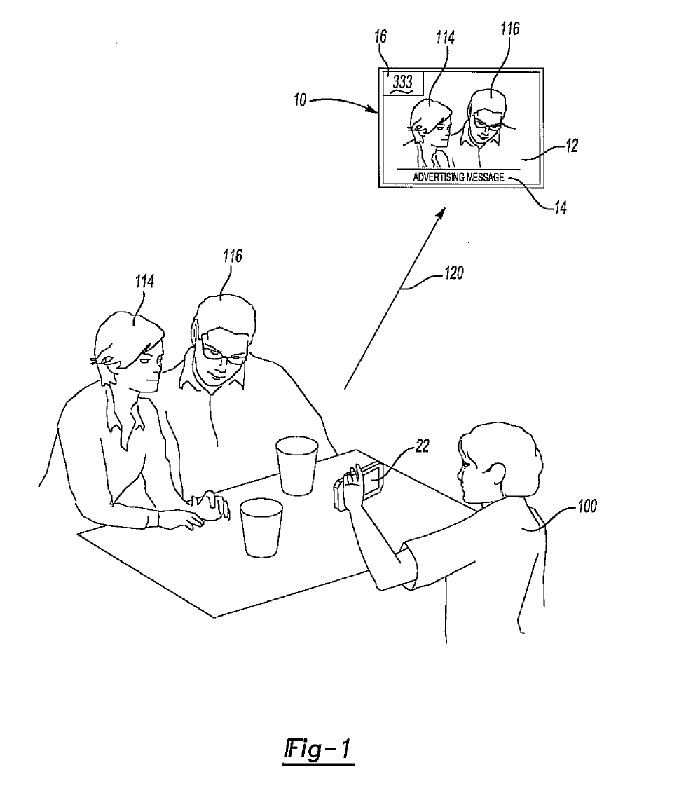

The present invention allows for a user to take a photograph on their mobile device and upload the photograph to a display unit at a public venue. The application is downloaded from various application providers and requires the user to enter an access code before allowing the user to photograph the subject. The access code is displayed only at the venue thereby preventing users outside of the venue from taking photographs away from the venue and uploading the photographs to the venue. In an alternative embodiment, the application requires the user to be at a specified GPS coordinate which may cause the picture to be rejected by the system if found to be outside of the location. Once a photograph is taken and uploaded, a computer based or human based monitoring system monitors the photographs or information and places photographs deemed to be appropriate in a second file. The photographs are then displayed on a public display monitor for viewing at the venue where the photograph was taken. FIG. 1 illustrates an environmental view of a user 100 taking a photograph with mobile device 22 of subjects 114, 116. Broadly defined, the photograph 13 is displayed on the monitoring device 12 and is uploaded via broad description route 120. The photograph 13 displays subjects 114, 116. The monitoring unit 12 displays the access code 16, in the present embodiment, as 333 in the upper left-hand corner of the display unit 12. The display 10 having the display unit 12 displays the photograph 13 and also displays an advertising message 14. A venue or the system operators are permitted to generate income or to cover funds for the photograph display method and apparatus by offering advertisers the opportunity to advertise their good or product in the advertising message 14. Alternatively, the venue operator may post personal messages or greetings to its patrons. Further, the venue operator may display specials in the space allotted for an advertising message 14 such as happy hour specials.

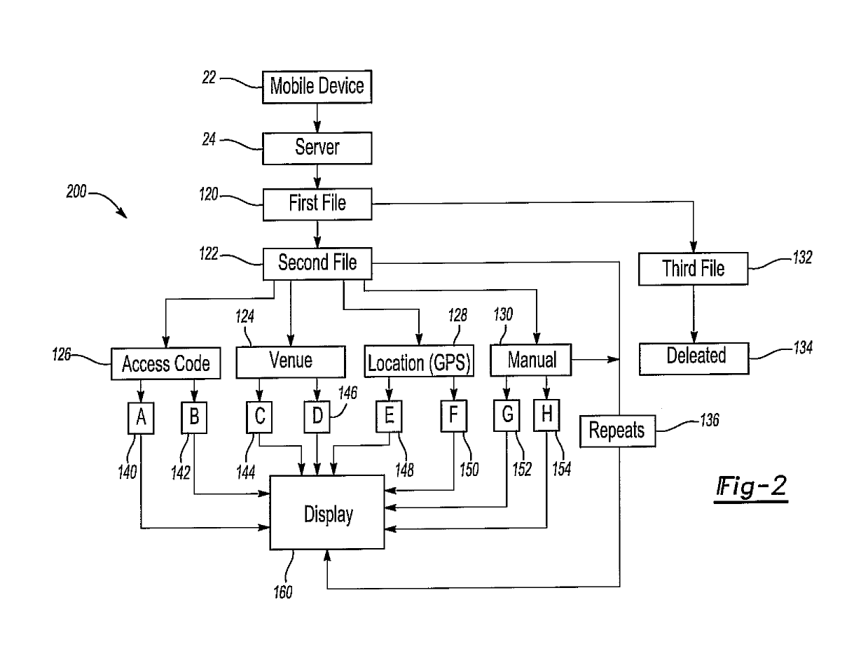

FIG. 2 illustrates a flowchart 200 illustrating the current process allowing the system to upload a photograph to a display unit 12. A mobile device 22 is in communication via the Internet to a server 24. The user 100 downloads an application to the mobile device 22 allowing the user to take a photograph. The photograph is uploaded to a server 24. The server then places the photograph in a first file or database 120. After a series of monitoring steps, the photograph is either placed in a second file 122 or a third file 132. If the monitoring process deems the photograph in the first file 120 appropriate for public viewing, the photograph is placed in the second file 122. If the monitoring process deems the photograph inappropriate for public viewing, the photograph is placed in the third file 132 and further deleted by the computer program 134. The deletion 134 of the photograph prevents the public from viewing inappropriate content. Once the photograph is placed in the second file 122, the photograph and associated user and corresponding venue collaborate the photograph with the venue either by access code 126, venue manipulation 124, location 128, or manual manipulation 130. If the access code 126 matches the access code of a predetermined venue, the photographs 140, 142 are displayed 160 at the venue. If the photographs located in the second file 122 are deemed appropriate by the venue 124, the photographs 144, 146 are publicly displayed 160. If the user location 128 is equal to or approximate to the GPS determined location of the venue, then the photographs E148 and F150 are publicly displayed 160. If in the event that a venue experiences a lack of or delay in users uploading photographs, the system automatically generates repeats 136 stored in the second file 122.

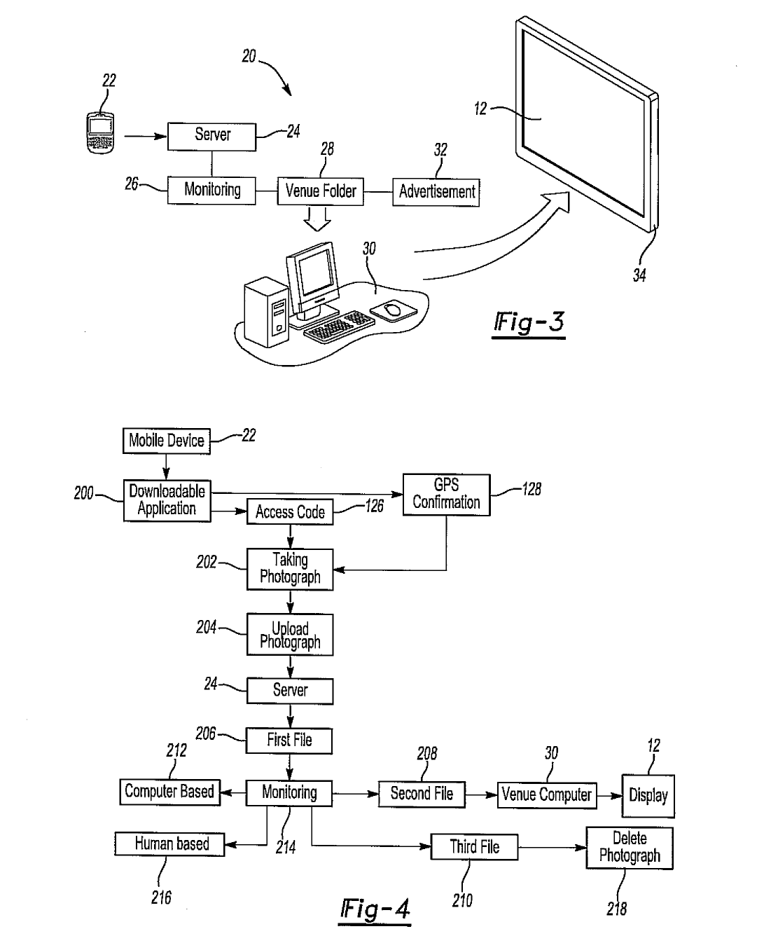

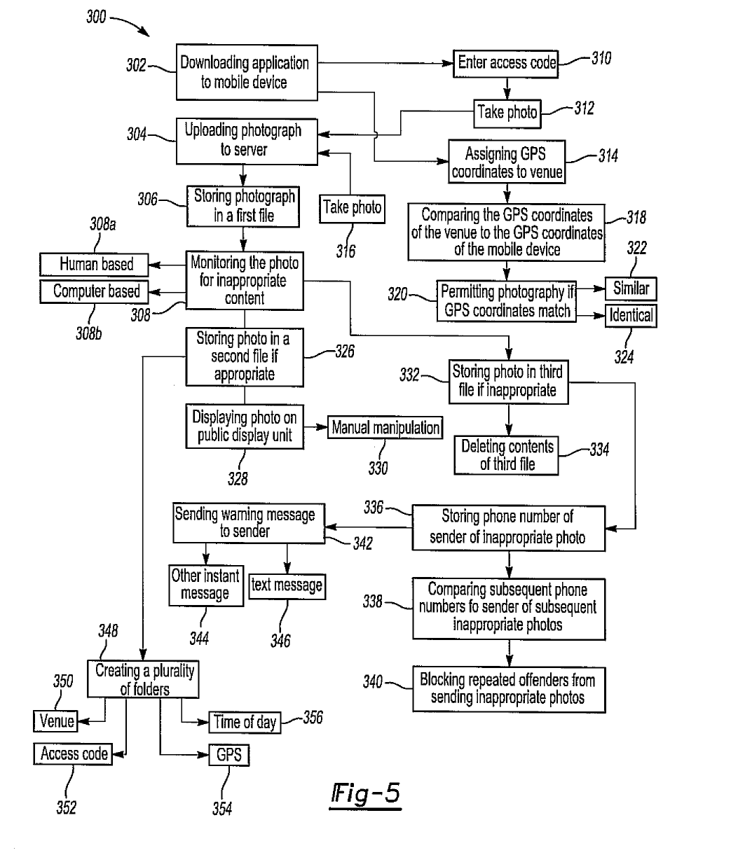

As shown by FIGS. 3 and 4, a photograph, or other media, is taken from a cellular device 22 through a designated application. The application is designated for use on smart phones having iTunes®, Android®, Blackberry®, etc. or other similar hardware. Before the user is allowed to take a photograph 12 on their smart phone, the user is required to enter an access code provided by the venue displaying the photograph 12. The access code is displayed on TVs or monitors 12 at the venue or club where the user is located. Among other reasons, the present invention is distinguished from the prior art mentioned in the background in that the present invention communicates to a computer through a data connection rather than directly transmitting information via SMS/text/MMS or Bluetooth/wireless. The system operates as a two communication method rather than one way (text message, SMS, etc.) The server is free to reject a user from using the application through the application. This is distinct from a one way communication method since a user of one way communication is free to continue sending text messages. After the user inputs the access code 16 into the smart phone 22, the GPS enabled smart phone will automatically locate the user. In a secondary embodiment, after the user inputs the access code 16 into the smart phone 22, the application automatically accepts the location of the user as being in the club, bar, or other venue.

Although traditionally a desktop style computer, the computer 30 may also be computer, computer system, operating system, mobile system, module, mobile computer, cell phone hardware or other hardware operable to process data.

In an alternative embodiment, the GPS will automatically match the location of the user to ensure they are within the parameters of the actual location of the venue. After the access code is entered and/or the GPS confirms the actual location of the user, a photograph is taken from the user's smart phone 22 through the application. The use of an access code and/or GPS satellite ensures that the user will only send photographs captured from their phone within that moment rather than allowing users to upload random photographs saved on their smart phones.

The application then uploads the photograph 12 and the access code 16 to a server 24 where it is further processed in the server application 26. The photographs are screened, either computer based 214 or human based 216, to ensure they are appropriate. Screening for appropriate pictures may be done by external software to screen for nudity, offensive signs, etc. The method 20 then provides for uploading the photograph 12 to an ftp folder or venue folder 28 according to the specified access code 16. The venue folders 28 are arranged on the server 26 or on the computer 30 according to access code 16 to allow for increased organization of the photographs 12.

As an alternative embodiment, the user has the option to include a message or written portion associated with the photograph 12. The message could include a description of the photograph, names of the people in the photograph 12, or a message (i.e. “happy birthday”) associated with the photograph 12 displayed on the monitoring device 34. In yet a further embodiment of the present invention, the user has the option of voting for a favorite photograph 12. Furthermore, users have the option of sending a message through the application without also sending a photograph 12. The user opens the application on their smart phone, enters the access code associated with the venue, and enters a message to be displayed on the monitoring device 34 without also sending a photograph 12.

Voting can be done through the same smart phone application or through a separate application downloadable through iTunes®, Android®, Blackberry®, etc. A user can select a favorite, most creative, funniest, etc. photograph 12 and select their preferred photograph 12 as indicated by the access code 16. The result of voting can be displayed on the monitoring device 34 or in a separate slide or screen. Further, the user may transmit comments to the display screen 34. These comments can be made with respect to a particular photograph 12, or just general comments.

Further, the system has the ability to allow a user to check in when a particular venue is reached. The user has the ability to connect the system with their Facebook page. The system can then upload the user's Facebook profile picture to the display screen 34.

The club or venue will have a simple machine or computer 30 enabling a file to be connected to the computer 30. The computer 30 is only allowed to download information on that particular file. After the computer 30 downloads the file, the computer then erases information on the server file to give more space for further pictures to be uploaded by other users. The computer stores the downloaded photographs 12 on the hard drive of the venue computer 30 and automatically sequences the photographs 12 in order of arrival or other specified sequencing parameter. The computer 30 then projects the photographs in sequence onto the monitoring device 34 connected to the computer 30. The monitoring device 34 may include a projector, TV, monitor, etc.

FIG. 6 illustrates the detailed flowchart depicting the method of the present invention 30. The method includes the steps of downloading an application 302 to a mobile device 22. The method 300 further includes the steps of entering an access code 310 allowing a user to take a photograph 312. A photograph is then uploaded 304 to a server allowing for storage of the photograph 306 in a first file. In a separate embodiment of the present invention, GPS coordinates are assigned 314 to a venue. The alternative method further includes the steps of comparing 318 the GPS coordinates of the venue to the GPS coordinates of the mobile device. The alternative method further includes the step of permitting photography 320 if the GPS coordinates match, if are similar 322, or identical 324. If the coordinates are similar 322 or identical, a user is permitted to take a photo 316.

Photographs are stored 306 in a first file. The method 300 then further includes the steps of monitoring 308 the photograph for inappropriate content. As previously discussed, monitoring is either human based 308a or computer based 308b allowing for screening of nudity, inappropriate content, etc. If the photograph is deemed appropriate, the method further includes the step of storing 326 a photo in a second file. If the photograph is deemed inappropriate at step 308, the method 300 then includes the step of storing 332 the photo in a third file. The contents of the third file are then deleted 334 since the content is inappropriate. In an alternative embodiment, if the contents of the third file 332 are deemed inappropriate, a separate file is created storing the phone numbers of the senders of inappropriate photos 336. This alternative method further includes comparing 338 subsequent phone numbers for senders of subsequent inappropriate photos. The method then includes blocking 340 repeated offenders from the sending of inappropriate photos.

Further alternatively, the method includes the step of storing phone numbers of the sender of inappropriate photos 336 and sending a warning message 342 to the sender of the inappropriate photographs. The sending 342 of the warning message is sent by either instant message 344 or text message 346.

If the photograph is deemed appropriate, the photo is stored in the second file 326. The contents of the second file are displayed 328 on the public display unit. The operator at the venue is allowed to manually manipulate 330 the order of the photographs.

Furthermore, once the photographs are deemed appropriate and stored in a second file at step 326, the database then creates a plurality of folders 348 according to a variety of parameters. The parameters include venue 350, access code 352, GPS 354, and/or time of day 356. The photos may then be displayed according to these various parameters 350, 352, 354, 356 and also may be manipulated 330 by the venue operator.

The present invention is not restricted to the illustrative examples and embodiments described above. The embodiments are not intended as limitations on the scope of the invention. Methods, apparatus, compositions, and the like described herein are exemplary and not intended to be limitations on the scope of the invention. The present invention is only limited by the scope of the appended claims. Changes therein and other uses will occur to those skilled in the art.

1. A computer based method of uploading and displaying media taken by a user on a mobile device wherein the media is displayed on a public display unit, the method comprising the steps of:
downloading an application on a mobile device, the application operable to allow a user to capture media on a mobile device;
uploading the media to a database server;
storing the media in a first file;
monitoring the media for inappropriate content;
storing the media in a second file if the media is deemed appropriate for public viewing; and
displaying the media on the public display unit, the display unit connected to a computer operable to receive the media stored in the second file.

2. The computer based method according to claim 1 further including the step of requiring the user of the application to enter an access code before capturing the media.

3. The computer based method according to claim 2 further including the step of displaying the access code at the location displaying the media on a public display unit thereby allowing patrons to display their media.

4. The computer based method according to claim 2 further including the step of requiring the access code to be between 1-5 alphanumeric characters.

5. The computer based method according to claim 4 further including the step of requiring the access code to be 3 alphanumeric characters.

6. The computer based method according to claim 1 further including the step of assigning specific GPS coordinates to a venue wherein the media is publicly displayed.

7. The computer based method according to claim 6 wherein the application on the mobile device has GPS capability.

8. The computer based method according to claim 7 wherein the GPS coordinates of the venue are compared to the current GPS coordinates of the mobile device having the application.

9. The computer based method according to claim 8 further including the step of allowing the user to capture media if the GPS coordinates of the mobile device and the GPS coordinates of the venue are similar.

10. The computer based method according to claim 8 further including the step of allowing the user to capture media if the GPS coordinates of the mobile device and the GPS coordinates of the venue are identical.

11. The computer based method according to claim 1 wherein the step of monitoring the media for inappropriate content is monitored by a human.

12. The computer based method according to claim 1 wherein the step of monitoring the media for inappropriate content is monitored by a computer based detection program.

13. The computer based method according to claim 1 wherein media is monitored for inappropriate content are deemed inappropriate are stored in a third file.

14. The computer based method according to claim 13 wherein the media is stored in the third file are deleted.

15. The computer based method according to claim 13 further including sending a message to the sender of the inappropriate media indicating that the media will not be displayed.

16. The computer based method according to claim 15 further including the step of storing the phone number of the sender of the inappropriate media.

17. The computer based method according to claim 16 further including the step of comparing subsequent phone numbers of senders of inappropriate media to check for repeat offenders.

18. The computer based method according to claim 17 further including the step of blocking repeated senders of inappropriate media from sending any further media.

19. The computer based method according to claim 1 further including the step of creating a plurality of folders within the second file, organizing each of the plurality of folders according to venue, corresponding access code and/or date, a working file created displaying the most recent media.

20. The computer based method according to claim 19 further including the steps of recycling previously seen media into a current photograph rotation if the number of photographs within the working file is below a predetermined number.

21. The computer based method according to claim 20 wherein the predetermined number is between 2-20.

22. The computer based method according to claim 1 further including the step of simultaneously displaying advertisements adjacent the media on the display unit.

23. The computer based method according to claim 1 further including the step of manually moving media between the first file, the second file, the third file and any sub-file contained within the first file, the second file or the third file.

24. The computer based method according to claim 1 further including a check-in feature allowing a user to communicate with the system where the user tells the system his current location.

25. The computer based method according to claim 1 further including a voting system allowing users to vote on their favorite media.

26. The computer based method according to claim 1 further including a voting system allowing users to comment on media.

27. The computer based method according to claim 1 wherein the media is a photograph.

28. The computer based method according to claim 1 wherein the media is a video.

29. The computer based method according to claim 1 wherein the media is text.

30. The computer based method according to claim 1 wherein the user connects his social media profile to the system.
